(19) United States
(12) Patent Application Publication
(10) Pub. No.: US 2019/0255581 A1
(43) Pub. Date: Aug. 22, 2019

(54) EQUIPMENT FOR AND METHOD OF RECYCLING WINDOW PANEL

(71) Applicants: Samsung Display Co., Ltd., Yongin-Si (KR); C & S ENGINEERING CO., LTD., Hwaseong-si (KR)

(72) Inventors: Jinwook YANG, Hwaseong-si (KR); Heechang KIM, Hwaseong-si (KR); Chang-mo PARK, Seoul (KR); Jongman BAE, Hwaseong-si (KR); Soyeon EOM, Daegu (KR); Bongkee LEE, Hwaseong-si (KR); Hyoungyoul KIM, Osan-si (KR)

(21) Appl. No.: 16/279,890

(22) Filed: Feb. 19, 2019

(30) Foreign Application Priority Data
Feb. 19, 2018 (KR) 10-2018-0019438

(51) Int. Cl. B08B 11/04; B08B 1/00; B08B 1/04

(52) U.S. Cl. CPC B08B 11/04; B08B 2220/01; B08B 1/04; B08B 1/006

(57) ABSTRACT

A window panel recycling equipment may include a first cleaning pad assembly, a first driving member rotating the first cleaning pad assembly, and a cleaning solution supplying member supplying a cleaning solution to the first cleaning pad assembly. The first cleaning pad assembly may include a first rotating member coupled to the first driving member and a first cleaning pad coupled to the first rotating member. The first cleaning pad may have a cylindrical shape and may have a plurality of pores defined therein.

### CROSS-REFERENCE TO RELATED APPLICATIONS

This U.S. non-provisional patent application claims priority under 35 U.S.C. § 119 to Korean Patent Application No. 10-2018-0019438, filed on Feb. 19, 2018, in the Korean Intellectual Property Office, the disclosure of which is hereby incorporated by reference in its entirety.

### BACKGROUND OF THE INVENTION

The present disclosure relates to a window panel recycling equipment and a window panel recycling method, and in particular, to equipment for and a method of recycling a window panel while preventing a light-blocking pattern from being damaged.

Various electronic devices, such as smart phones, tablet computers, notebook computers, and smart television sets, are being developed. A typical electronic device includes a display device that is used to provide visual information to a user. Some electronic devices may further include various electronic modules, in addition to the display device.

The electronic device may include a window panel that is provided as the outermost part of the electronic device. The window panel provides a display surface, on which an image is displayed, and a bezel region is defined along an edge of the window panel. To provide a three-dimensional display surface, a window panel may be configured to have a three-dimensional shape. The window panel of the three-dimensional shape is expensive.

### SUMMARY

An embodiment of the inventive concept provides equipment for recycling a window panel without damaging a light-blocking pattern.

An embodiment of the inventive concept provides a method of recycling a window panel without damaging a light-blocking pattern.

According to an embodiment of the inventive concept, a window panel recycling equipment may include a first cleaning pad assembly, a first driving member rotating the first cleaning pad assembly, and a cleaning solution supplying member supplying a cleaning solution to the first cleaning pad assembly. The first cleaning pad assembly may include a first rotating member coupled to the first driving member and a first cleaning pad coupled to the first rotating member. The first cleaning pad may have a cylindrical shape and may have a plurality of pores defined therein.

In an embodiment, the first rotating member may include: a passage that allows the cleaning solution to flow in an extension direction of the first rotating member, and an exit hole that allows the cleaning solution to be discharged from the passage to an outside of the first rotating member.

In an embodiment, the recycling equipment may further include a cleaning solution supply pipe coupled to the first rotating member.

In an embodiment, the recycling equipment may further include a dummy pipe coupled to the first rotating member.

In an embodiment, the first cleaning pad may include an elastic member and a powder layer coated on the elastic member.

In an embodiment, the powder layer may include a synthetic resin and ceramic powder particles that are mixed on the synthetic resin and have a diameter ranging from 0.3 μm to 0.5 μm.

In an embodiment, the first cleaning pad assembly may be provided in plural.

In an embodiment, the cleaning solution may include 90 weight percent (wt %) to 100 wt % of ethylcyclohexane, 0 wt % to 5 wt % of C9-11 isoalkanes, and 0 wt % to 10 wt % of C10-13 isoalkanes with respect to 100 wt % of the cleaning solution.

In an embodiment, the recycling equipment may further include a second cleaning pad assembly and a second driving member rotating the second cleaning pad assembly. The second cleaning pad assembly may include a second rotating member coupled to the second driving member and a second cleaning pad coupled to the second rotating member. The second cleaning pad may have a disk shape and may have a plurality of pores defined therein.

In an embodiment, the cleaning solution supplying member may be configured to supply the cleaning solution to the second cleaning pad assembly, and the second rotating member may include a passage that allows the cleaning solution to flow in an extension direction of the second rotating member, and an exit hole that allows the cleaning solution to be discharged from the passage of the second rotating member to an outside of the second rotating member.

In an embodiment, the recycling equipment may further include a cleaning solution supply pipe coupled to the second rotating member. The recycling equipment may further include a dummy pipe coupled to the second rotating member.

In an embodiment, the first cleaning pad may include an outer circumference surface that is used to remove an adhesive residue from a curved region of a window panel by rotating the first cleaning pad.

In an embodiment, the window panel may include a base substrate and a light-blocking pattern that is directly provided on an edge region of the base substrate.

In an embodiment, the recycling equipment may further include a cleaning solution tank storing the cleaning solution, wherein the window panel is dipped in the cleaning solution, a washing solution tank storing a washing solution, wherein the window panel is dipped in the washing solution, an air dryer drying the window panel using an air, and a fiber dryer drying the window panel using a fiber.

According to an embodiment of the inventive concept, a window panel recycling method may include performing a chemical cleaning step to dip a window panel in a cleaning solution tank, the window panel including a base substrate including a curved region and a flat region, a light-blocking pattern that overlaps the curved region and is directly provided on the base substrate, and an adhesive residue, performing a first physical cleaning step to clean the curved region of the window panel with a first cleaning pad assembly, and removing the cleaning solution from the window panel.

The first cleaning pad assembly may include a first cleaning pad having a cylindrical shape and having a plurality of pores defined therein. The first cleaning pad may rotate, and an outer circumference surface of the first cleaning pad may rub against the adhesive residue. The cleaning solution may be supplied onto an internal circumference surface of the first cleaning pad while the first cleaning pad rotates.

In an embodiment, the method may further include performing a second physical cleaning step to clean the flat region of the window panel with a second cleaning pad assembly. The second cleaning pad assembly may include a second cleaning pad having a plurality of pores defined therein and having a disk shape. The second cleaning pad may rotate, and a bottom surface of the second cleaning pad may rub against the adhesive residue.

In an embodiment, the cleaning solution may be supplied onto an internal circumference surface of the second cleaning pad while the second cleaning pad rotates.

In an embodiment, the removing of the cleaning solution from the window panel may include dipping the window panel into a washing solution tank.

In an embodiment, the removing of the cleaning solution from the window panel may include taking the window panel out of the washing solution tank and drying the window panel using at least one of an air or a fiber.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a perspective view illustrating a display device according to an embodiment of the inventive concept.

FIGS. 2A to 2C are sectional views illustrating a display device according to an embodiment of the inventive concept.

FIG. 3 is a flow chart illustrating a method of recycling a window panel of a display device according to an embodiment of the inventive concept.

FIG. 4A is a perspective view illustrating a window panel according to an embodiment of the inventive concept.

FIGS. 4B and 4C are sectional views illustrating a portion of a window panel according to an embodiment of the inventive concept.

FIG. 5 is a flow chart illustrating a process of removing a residue of an adhesive member, according to an embodiment of the inventive concept.

FIG. 6 is a diagram schematically illustrating an in-line type window panel recycling equipment.

FIG. 7A is a perspective view illustrating a first adhesive removing device according to an embodiment of the inventive concept.

FIGS. 7B to 7F are plan views illustrating operations of a first cleaning pad assembly according to an embodiment of the inventive concept.

FIG. 8A is a perspective view illustrating a first cleaning pad assembly according to an embodiment of the inventive concept.

FIG. 8B is an enlarged perspective view illustrating a cleaning pad of the first cleaning pad assembly shown in FIG. 8A.

FIG. 8C is a sectional view of the cleaning pad shown in FIG. 8B.

FIG. 8D is a perspective view illustrating a first cleaning pad assembly according to an embodiment of the inventive concept.

FIG. 9A is a perspective view illustrating a second adhesive removing device according to an embodiment of the inventive concept.

FIG. 9B is a perspective view illustrating a second cleaning pad assembly according to an embodiment of the inventive concept.

FIG. 9C is a sectional view of a cleaning pad shown in FIG. 9B.

FIG. 9D is a perspective view illustrating a second cleaning pad assembly according to an embodiment of the inventive concept.

It should be noted that these figures are intended to illustrate the general characteristics of methods, structure, and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions, and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concept will now be described more fully with reference to the accompanying drawings, in which example embodiments are shown. Example embodiments of the inventive concept may, however, be embodied in many different forms and should not be construed as being limited to the embodiments set forth herein; rather, these embodiments are provided so that the present disclosure will be thorough and complete, and will fully convey the concept of example embodiments to those of ordinary skill in the art. In the drawings, the thicknesses of layers and regions may be exaggerated for clarity. Like reference numerals in the drawings denote like elements, and thus their description will be omitted.

It will be understood that when an element or a layer is referred to as being “connected” or “coupled” to another element or layer, it can be directly connected or coupled to the other element or layer, or one or more intervening elements may be present. In contrast, when an element or a layer is referred to as being “directly connected” or “directly coupled” to another element or layer, there are no intervening elements present. Other words used to describe the relationship between elements or layers should be interpreted in a like fashion (e.g., “between” versus “directly between,” “adjacent” versus “directly adjacent,” “on” versus “directly on”). Like numbers indicate like elements throughout. As used herein the term “and/or” includes any and all combinations of one or more of the associated listed items.

It will be understood that, although the terms “first,” “second,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations), and the spatially relative descriptors used herein are interpreted accordingly.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments of the inventive concept are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concept should not be construed as limited to the particular shapes of regions illustrated herein, but are to include deviations in shapes that result, for example, from manufacturing.

Unless otherwise defined, terms (including technical and scientific terms) used herein have the same meaning as commonly understood by one of ordinary skill in the art to which example embodiments of the inventive concept belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

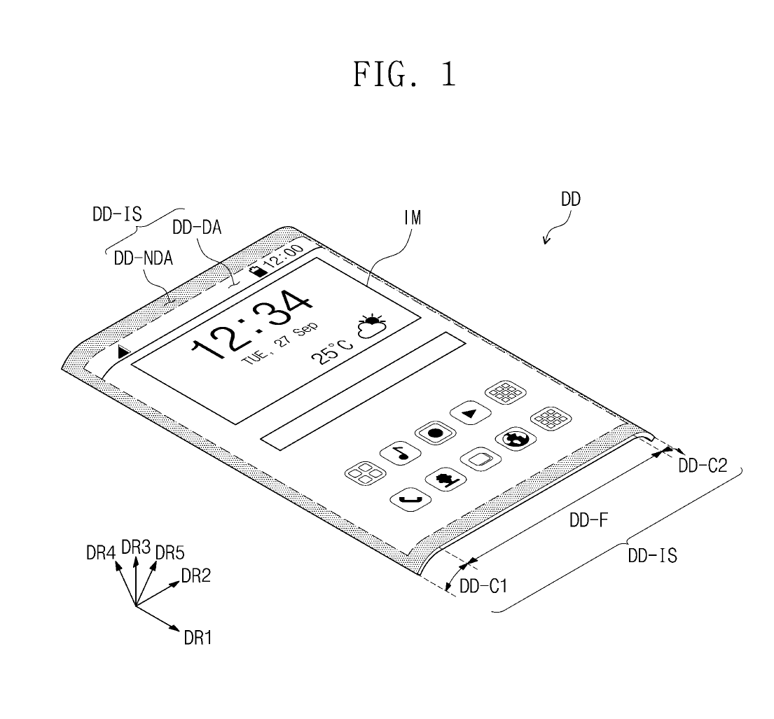

FIG. 1 is a perspective view illustrating a display device DD according to an embodiment of the inventive concept.

As shown in FIG. 1, the display device DD may include a display surface DD-IS that is used to display an image IM. The display surface DD-IS may include at least two different regions. For example, the display surface DD-IS may include a display region DD-DA, on which the image IM is displayed, and a non-display region DD-NDA that is adjacent to the display region DD-DA. The non-display region DD-NDA may form a bezel region of the display device DD. The non-display region DD-NDA may surround the display region DD-DA. However, the inventive concept is not limited to this example. In other embodiments, shapes of the display region DD-DA and the non-display region DD-NDA may be variously changed in a complementary manner. For example, the non-display region DD-NDA may be provided at only regions facing each other in a first direction axis DR1.

The display surface DD-IS may include at least two different regions, according to a display direction of the image IM. For example, the display surface DD-IS may include a flat region DD-F, a first curved region DD-C1, and a second curved region and DD-C2. FIG. 1 illustrates an example in which the display surface DD-IS includes two curved regions DD-C1 and DD-C2 that face each other in a second direction axis DR2.

The flat region DD-F may be parallel to a plane defined by the first direction axis DR1 and the second direction axis DR2. A normal direction of the flat region DD-F (i.e., a thickness direction of the display device DD) will be referred to as a third direction axis DR3. When a display direction of the image IM is set to be the third direction axis DR3, the third direction axis DR3 may be used to differentiate a front or top surface of each element of the display device DD from a rear or bottom surface. Hereinafter, first to third directions refer to directions indicated by the first to third direction axes DR1, DR2, and DR3, respectively, and will be identified with the same reference numbers.

Each of the first and second curved regions DD-C1 and DD-C2 may extend from the flat region DD-F and have a curved outer surface. The first curved region DD-C1 may display a portion of the image IM in a fourth direction axis DR4, and the second curved region DD-C2 may display another portion of the image IM in a fifth direction axis DR5.

In one embodiment, the display device DD may be a rigid display device. However, the inventive concept is not limited thereto, and in an embodiment, the display device DD may be a flexible display device or a rollable display device. In the present embodiment, the display device DD that can be used for a cellphone, is exemplarily illustrated. Although not shown, the cellphone may further include an electronic module, a camera module, a power module, and so forth that are mounted on a mainboard and are provided in a bracket or case, along with the display device DD. In some embodiments, the display device DD may be used for large-sized electronic devices (e.g., television sets and monitors) or small- or medium-sized electronic devices (e.g., tablet computers, car navigation systems, game machines, and smart watches).

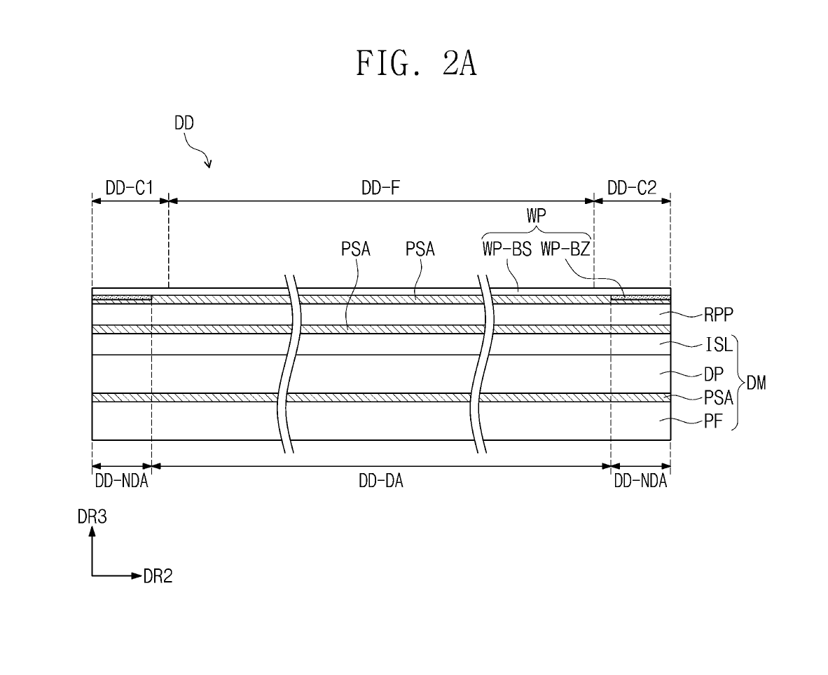

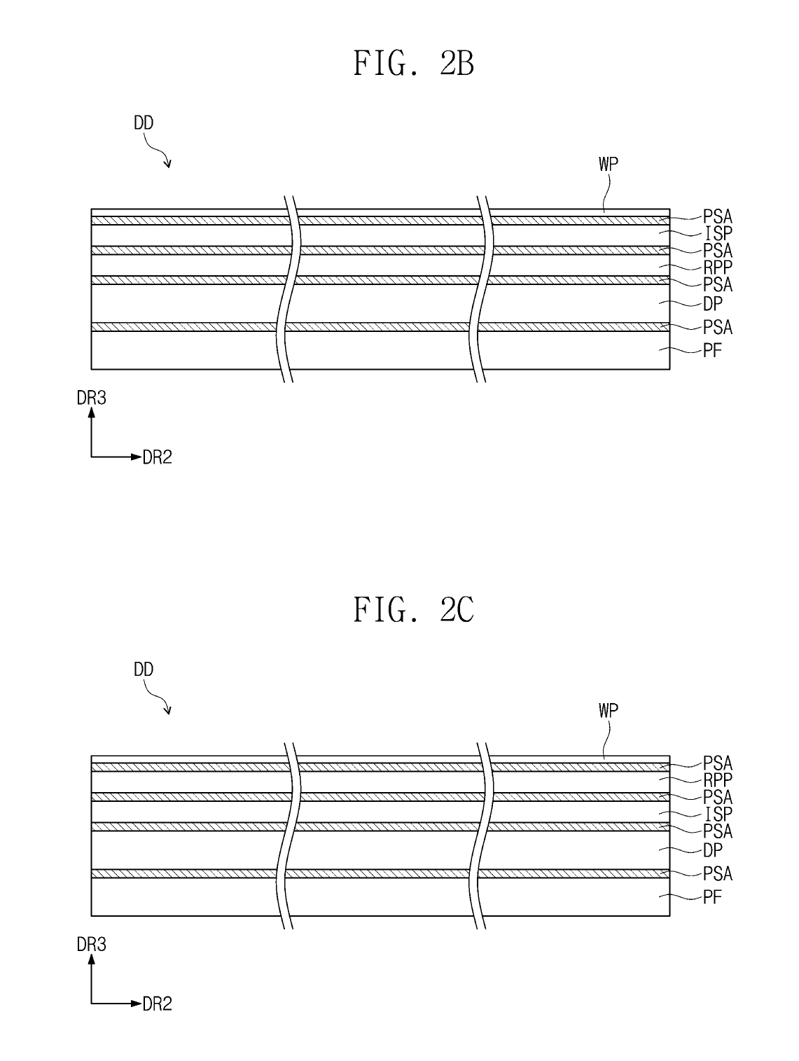

FIGS. 2A to 2C are sectional views illustrating some examples of the display device DD according to an embodiment of the inventive concept. FIGS. 2A to 2C illustrate vertical sections, each of which is defined by the second and third directions DR2 and DR3. In FIGS. 2A to 2C, the display devices DD are illustrated in a simplified manner in order to describe a stacking structure of panels and/or elements or modules therein. Furthermore, in FIGS. 2A to 2C, the curved regions DD-C1 and DD-C2 of FIG. 1 are illustrated in an unfolded shape.

The display device DD according to an embodiment of the inventive concept may include a display module DM and a window panel WP. The display module DM may include a display panel, a protection member, a pressure-sensing unit, and an anti-reflection unit. At least two of the display panel, the pressure-sensing unit, and the anti-reflection unit constituting the display module DM may be successively formed by one or more successive processes or may be combined with each other by an adhesive member. In an embodiment, one or more of the anti-reflection unit, the window panel, and the protection member may be replaced with other units or may be omitted.

FIGS. 2A to 2C illustrate examples in which a pressure sensitive adhesive film PSA is used as the adhesive member. In various embodiments to be described below, the adhesive member may be an adhesive material or a gluing agent, but the inventive concept is not limited thereto.

In FIGS. 2A to 2C, if a unit (e.g., the pressure-sensing unit or the anti-reflection unit) is formed on another element by a successive process, the unit may be referred to as a layer. If a unit (e.g., the pressure-sensing unit or the anti-reflection unit) is combined to another element by an adhesive member, the unit may be referred to as a panel. In this regard, a panel may include a base layer (e.g., a synthetic resin film, a composite film, or a glass substrate) providing a base surface, but a layer may not have a base layer. In other words, a layer may be placed on a base surface that is provided by another element or unit. Herein, the pressure-sensing unit and the anti-reflection unit may be referred to as an input-sensing panel ISP and an anti-reflection panel RPP or referred to as an input-sensing layer ISL and an anti-reflection layer RPL based on the presence or absence of a base layer. The following examples show the input-sensing panel ISP and the anti-reflection panel RPP. However, it is understood that the input-sensing panel ISP and the anti-reflection panel RRP may be respectively replaced with the input-sensing layer ISL and the anti-reflection layer RPL without deviating from the scope of the present disclosure.

As shown in FIG. 2A, the display device DD may include the display module DM and the window panel WP. The display module DM may include a display panel DP, a protection member PF, an input-sensing layer ISL, and an anti-reflection panel RPP. The pressure sensitive adhesive film PSA may be respectively provided between the display panel DP and the protection member PF, between the input-sensing layer ISL and the anti-reflection panel RPP, and between the anti-reflection panel RPP and the window panel WP. The input-sensing layer ISL may be directly provided on the display panel DP. In the present disclosure, the expression “an element B1 may be directly provided on an element Al” indicates that an adhesive member may not be provided between the elements Al and B1. After the formation of the element Al, the element B1 may be formed on a base surface that is provided by the element Al through a successive process.

The display panel DP may generate an image, and the input-sensing layer ISL may obtain information on coordinates of an external input (e.g., a touch event). The protection member PF may support the display panel DP and protect the display panel DP from an external impact or contamination.

According to an embodiment of the inventive concept, the display panel DP may be a light-emitting type display panel, but the inventive concept is not limited to a specific type of the display panel DP. For example, the display panel DP may be an organic light emitting display panel or a quantum dot light-emitting display panel. A light emitting layer of the organic light emitting display panel may be formed of or include an organic light emitting material. A light emitting layer of the quantum dot light-emitting display panel may include quantum dots and/or quantum rods. For the sake of simplicity, the following description will refer to an example in which the display panel DP is the organic light emitting display panel.

In an embodiment, the input-sensing layer ISL may be substantially the same as a capacitance-type touch panel. The input-sensing layer ISL may include dot-type sensor patterns and signal lines connected to the sensor patterns. The input-sensing layer ISL may include sensor electrodes crossing each other and signal lines connected to the sensor electrodes.

The protection member PF may include a plastic film serving as a base layer. The plastic film may include a thermoplastic resin. Materials for the protection member PF are not limited thereto, and the protection member PF may include organic/inorganic composites. For example, the protection member PF may include a porous organic layer and an inorganic material that is formed to fill pores of the porous organic layer.

The anti-reflection panel RPP may be reduce reflectance of an external light that is incident from an outer space to the window panel WP. In an embodiment, the anti-reflection panel RPP may include a phase retarder and a polarizer. The phase retarder may be of a film type or a liquid crystal coating type and may include a λ/2 phase retarder and/or a λ/4 phase retarder. The polarizer may also be of a film type or a liquid crystal coating type. The polarizer of the film type may include an elongated synthetic resin film, whereas the polarizer of the liquid crystal coating type may include liquid crystals arranged with a specific orientation. The phase retarder and the polarizer may further include a protection film. At least one of the phase retarder, the polarizer, and the protection film may be used as a base layer of the anti-reflection panel RPP.

In an embodiment, the anti-reflection panel RPP may include color filters. The anti-reflection panel RPP may further include a black matrix that is provided adjacent to the color filters. In an embodiment, the anti-reflection panel RPP may include a destructive interference structure. For example, the destructive interference structure may include a first reflection layer and a second reflection layer that are provided on different layers.

In an embodiment, the window panel WP may include a base substrate WP-BS and a light-blocking pattern WP-BZ that is directly provided on a surface of the base substrate WP-BS. The base substrate WP-BS may be a glass substrate. However, the inventive concept is not limited thereto, and in an embodiment, the base substrate WP-BS may include a plastic substrate.

The light-blocking pattern WP-BZ may partially overlap the base substrate WP-BS. The light-blocking pattern WP-BZ may be provided on a rear surface of the base substrate WP-BS to define a bezel region of the display device DD (i.e., the non-display region DD-NDA of FIG. 1).

The light-blocking pattern WP-BZ may include a colored organic layer and may be directly formed on the rear surface of the base substrate WP-BS by various methods, for example, a coating method or a printing method. Although not shown, the window panel WP may further include a coating layer provided on the front surface of the base substrate WP-BS. The coating layer may include an anti-fingerprint layer, an anti-reflection layer, a hard coating layer, and so forth.

In FIGS. 2B and 2C, the window panel WP is illustrated in a simplified manner (e.g., without distinction of the base substrate WP-BS and the light-blocking pattern WP-BZ). A stacking order of the input-sensing panel ISP and the anti-reflection panel RPP may be changed, as shown in FIGS. 2B and 2C.

Although not shown, the display module DM according to an embodiment of the inventive concept may not have a separately-provided anti-reflection panel RPP. In an embodiment, the input-sensing panel ISP or the display panel DP may include a color filter or a destructive interference structure that serves as an anti-reflection unit.

A process of fabricating the display devices DD shown in FIGS. 2A to 2C may include preparing the display panel DP, the protection member PF, the input-sensing panel ISP, the anti-reflection panel RPP, and the window panel WP and performing a lamination process, in which the adhesive member PSA is used. After the fabrication of the display device DD is finished, a test process may be performed to examine the display device DD.

A failure of the display panel DP or the input-sensing panel ISP may lead to an abnormal operation of the display device DD. In addition, a misalignment issue in a lamination process may result in an abnormal operation of the display device DD. A recycling process may be performed on the abnormal display device DD to reuse the window panel WP.

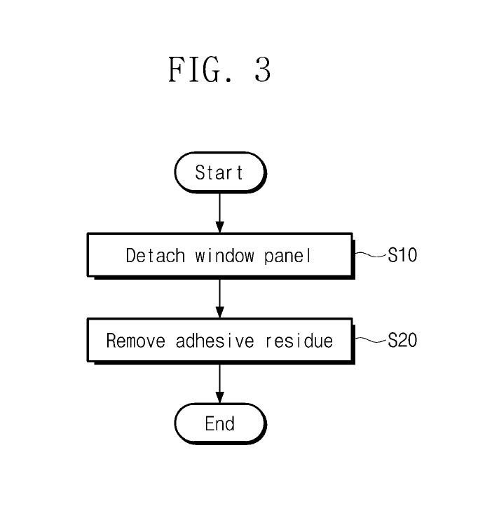

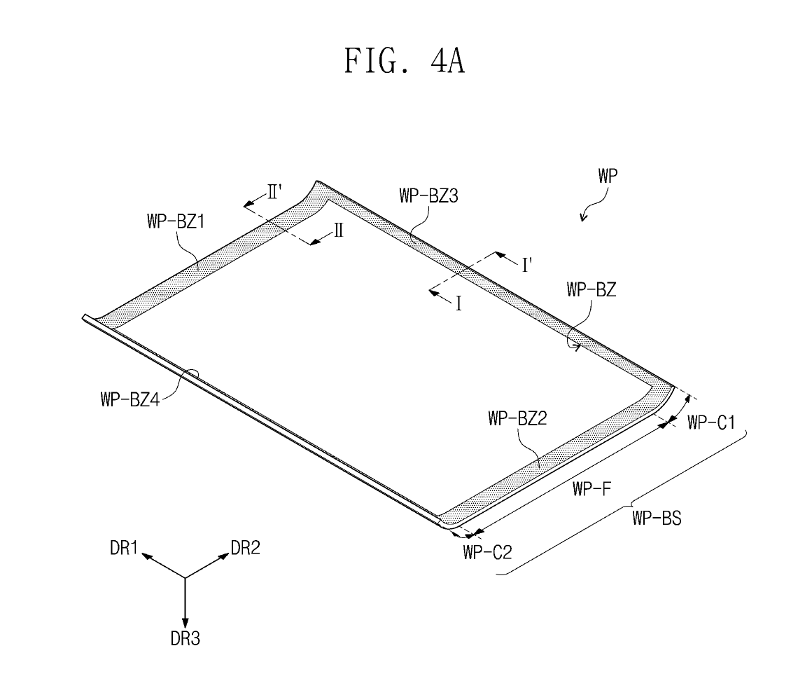

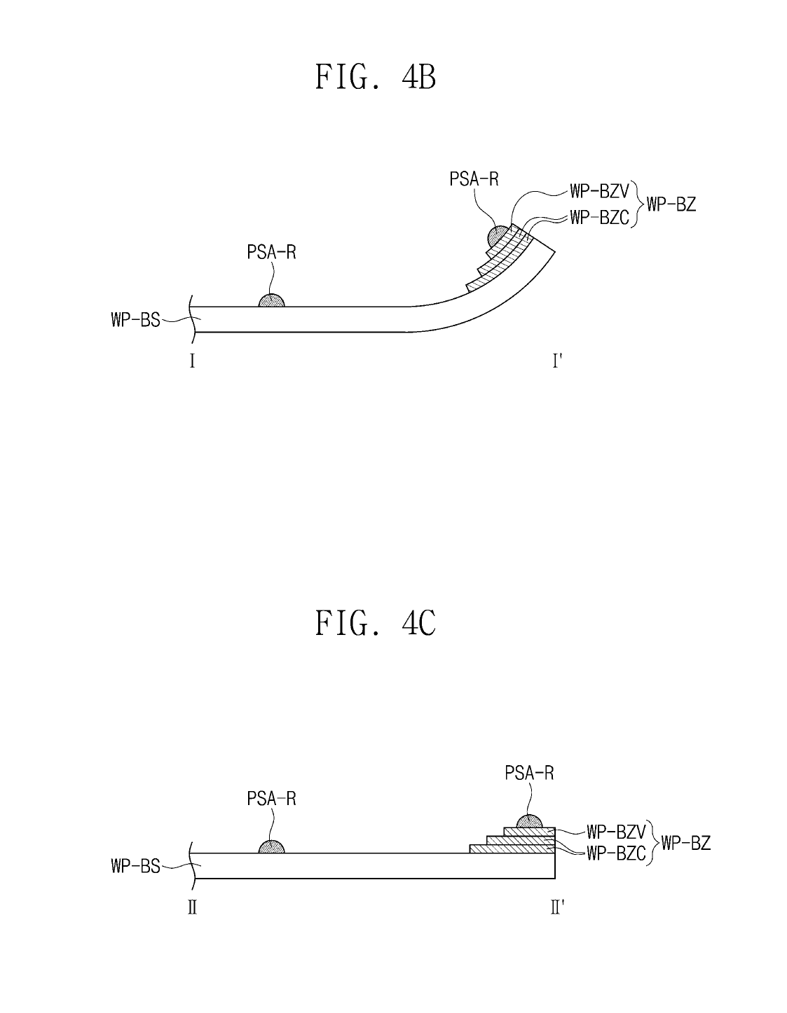

FIG. 3 is a flow chart illustrating a method of recycling the window panel WP of the display device DD according to an embodiment of the inventive concept. FIG. 4A is a perspective view illustrating the window panel WP according to an embodiment of the inventive concept. FIGS. 4B and 4C are sectional views illustrating a portion of the window panel WP taken along the lines I-I′ and II-II′ of FIG. 4A, according to an embodiment of the inventive concept.

As shown in FIG. 3, if the display device DD of FIG. 2A, 2B, or 2C is determined to be abnormal, the window panel WP may be detached from the display device DD (in S10). The inventive concept is not limited to a specific method for detaching the window panel WP from the display device DD.

In an embodiment, liquefied nitrogen may be used to quench the adhesive member PSA (see FIG. 2A) that is disposed between the display module DM and the window panel WP, and then, the display module DM and the window panel WP may be physically separated from each other. In the case where the display device DD is dipped in a tank storing the liquefied nitrogen, the adhesive member PSA may be chilled, thereby depriving its adhesive property. This may facilitate detachment of the window panel WP from the display module DM without scratching or damaging the window panel WP.

FIGS. 4A to 4C illustrate the window panel WP separated from the display device DD, and the window panel WP is disposed to have a rear surface facing upward. The base substrate WP-BS may include a flat region WP-F and curved regions WP-C1 and WP-C2 that respectively correspond to the flat region DD-F and the curved regions DD-C1 and DD-C2 of FIG. 1. The curved regions WP-C1 and WP-C2 may be formed by bending opposite edge regions of a flat base substrate. Each of the curved regions WP-C1 and WP-C2 may have a predetermined curvature and may have at least a curved outer surface.

The light-blocking pattern WP-BZ includes a first portion WP-BZ1 and a second portion WP-BZ2 that are spaced apart from each other in the first direction DR1 and respectively overlap the flat region WP-F. The light-blocking pattern WP-BZ further includes a third portion WP-BZ3 and a fourth portion WP-BZ4 that are spaced apart from each other in the second direction DR2 and respectively overlap the curved regions WP-C1 and WP-C2. In the present embodiment, the third portion WP-BZ3 and the fourth portion WP-BZ4 may partially overlap the first curved region WP-C1 and the second curved region WP-C2, respectively, but the inventive concept is not limited thereto.

In one embodiment, the first to fourth portions WP-BZ1 to WP-BZ4 may be formed by the same process and may have the same stacking structure, but the inventive concept is not limited thereto. Although not shown in FIGS. 4A to 4C, openings may be defined in a region of the light-blocking pattern WP-BZ. The openings may correspond to passages, through which light is incident into optical sensors of an electronic device. For example, a camera module mounted on a cellular phone can receive optical signals through the openings.

As shown in FIGS. 4B and 4C, the light-blocking pattern WP-BZ may include at least one organic layer. The light-blocking pattern WP-BZ may include at least one color layer WP-BZC that is directly provided on a surface of the base substrate WP-BS (e.g., a surface for the display device DD shown in FIG. 2A) and a cover layer WP-BZV that is provided on the color layer WP-BZC. The color layer WP-BZC having a double-layered structure is exemplarily illustrated.

The color layer WP-BZC may be a synthetic resin layer containing dye or pigment. A color of the color layer WP-BZC may be one of white, blue, red, and black, depending on the dye or pigment. At least one of the color layers WP-BZC may have a black color.

A synthetic resin composite containing dye or pigment may be directly printed on the base substrate WP-BS and may be dried to form the color layer WP-BZC. The synthetic resin composite may further include a photoinitiator, a dispersing agent, or the like. The color layer WP-BZC may include an acrylic-based material.

The cover layer WP-BZV may include a material having an adhesive strength stronger than the color layer WP-BZC. The cover layer WP-BZV may include a polyester-based material. In an embodiment, the cover layer WP-BZV may be omitted.

After a process of separating the display module DM and the window panel WP from each other, an adhesive residue PSA-R may remain on the cover layer WP-BZV and/or on the rear surface of the flat region WP-F.

Referring to FIGS. 3, 4B, and 4C, the adhesive residue PSA-R may be removed to reuse the window panel WP (in S20). Here, a window panel recycling equipment and a window panel recycling method according to an embodiment of the inventive concept may be used to selectively remove the adhesive residue PSA-R, without damaging the light-blocking pattern WP-BZ. The window panel recycling equipment and the window panel recycling method according to an embodiment of the inventive concept will be described in more detail below.

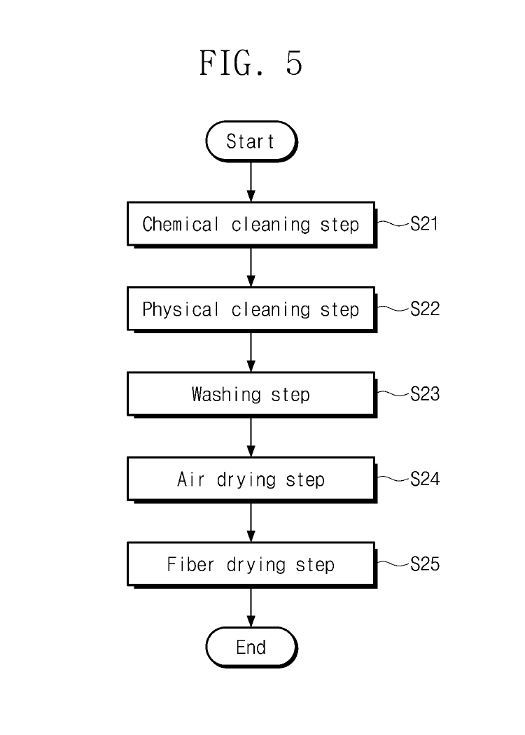

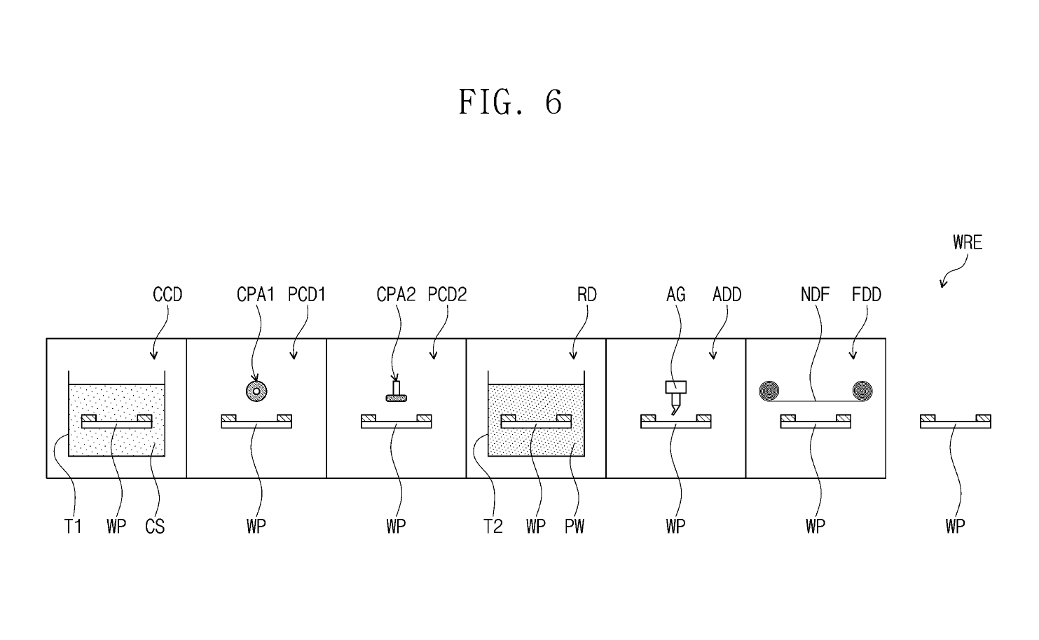

FIG. 5 is a flow chart illustrating a process of removing a residue of an adhesive member, according to an embodiment of the inventive concept. FIG. 6 is a diagram schematically illustrating an in-line type window panel recycling equipment WRE. Hereinafter, the process of removing a residue of an adhesive member and the window panel recycling equipment WRE according to one embodiment will be described with reference to FIGS. 5 and 6.

Referring to FIG. 5, the process of removing a residue of an adhesive member includes a chemical cleaning step S21, a physical cleaning step S22, a washing step S23, an air drying step S24, and a fiber drying step S25. Referring to FIG. 6, the window panel recycling equipment WRE includes a chemical cleaning device CCD, physical cleaning devices PCD1 and PCD2, a washing device RD, an air dryer ADD, and a fiber dryer FDD. The physical cleaning devices PCD1 and PCD2 may also be referred to as first and second adhesive removing devices PCD1 and PCD2, respectively. Although not shown in FIG. 6, the window panel recycling equipment WRE may further include a storage tank that is used to store liquefied nitrogen and a separation device that is used to physically separate the display module DM and the window panel WP from each other. These additional devices may be provided in front of the chemical cleaning device CCD.

As shown in FIGS. 5 and 6, the window panel WP shown in FIGS. 4A to 4C may be dipped in a cleaning solution tank T1 to perform the chemical cleaning step S21. A cleaning solution CS may be a chemical solution for removing an adhesive member, but the inventive concept is not limited to a specific solution. After the window panel WP is dipped in the cleaning solution CS, the adhesive residue PSA-R (e.g., see FIGS. 4B and 4C) may be dissolved and removed or may be swelled and softened to be easily removed.

In one embodiment, the cleaning solution CS may be non-alcoholic cleaning solution. The cleaning solution CS may include 90 weight percent (wt %) to 100 wt % of ethylcyclohexane, 0 wt % to 5 wt % of C9-11 isoalkanes, and 0 wt % to 10 wt % of C10-13 isoalkanes with respect to 100 wt % of the cleaning solution CS. Such non-alcoholic cleaning solution may have high solubility and permeability to an adhesive material.

As shown in FIGS. 5 and 6, the physical cleaning step S22 may be performed on the window panel WP, after the chemical cleaning step S21. The first adhesive removing device PCD1 may be used to perform a first physical cleaning step of physically removing the adhesive residue PSA-R that is chemically cleaned in the chemical cleaning step S21 in some regions (e.g., the curved regions DD-C1 and DD-C2). In addition, the second adhesive removing device PCD2 may be used to perform a second physical cleaning step of physically removing the adhesive residue PSA-R in other regions (e.g., the flat region DD-F). The first adhesive removing device PCD1 and the second adhesive removing device PCD2 may include a first cleaning pad assembly CPA1 and a second cleaning pad assembly CPA2, respectively, as will be described below.

As shown in FIGS. 5 and 6, after the physical cleaning step S22, the washing step S23 may be performed to dip and wash the window panel WP that is chemically and physically cleaned in a washing solution tank T2. A washing solution PW may be used to remove the cleaning solution CS and the adhesive residue PSA-R from the window panel WP. The washing solution PW may include de-ionized water.

As shown in FIGS. 5 and 6, after the washing step S23, an air drying step S24 may be performed on the window panel WP. The air dryer ADD may include an air gun AG that provides an air stream or an air jet to the window panel WP. The air gun AG may be used to remove most of the washing solution PW from a surface of the window panel WP.

As shown in FIGS. 5 and 6, after the air drying step S24, the fiber drying step S25 may be performed on the window panel WP. The fiber dryer FDD may include a fiber NDF provided from a roller. The fiber NDF may be a polyester fiber. The fiber NDF may be used to wipe off the washing solution PS that remains on the window panel WP.

In the process of removing an adhesive residue according to an embodiment of the inventive concept, at least one of the air drying step S24 and the fiber drying step S25 may be omitted. In addition, one or more of the air drying step S24 and the fiber drying step S25 may be replaced with a thermal drying step. In this case, the configuration of the window panel recycling equipment WRE may be changed accordingly.

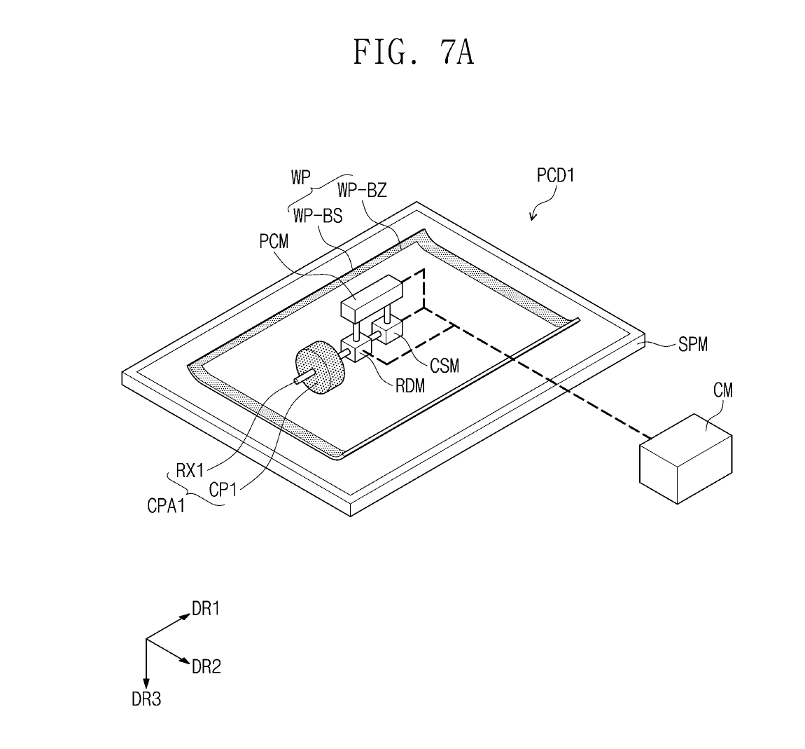

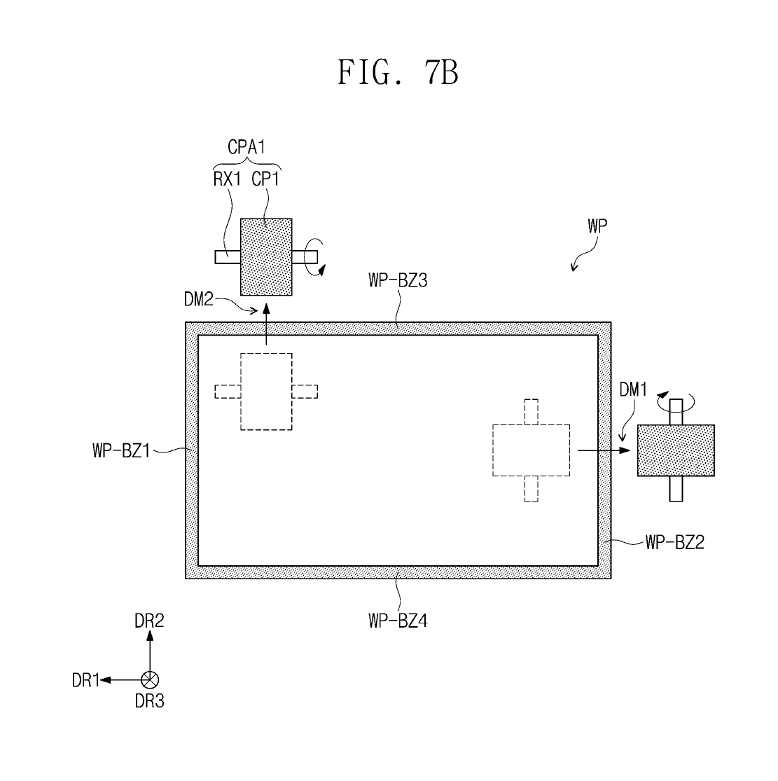

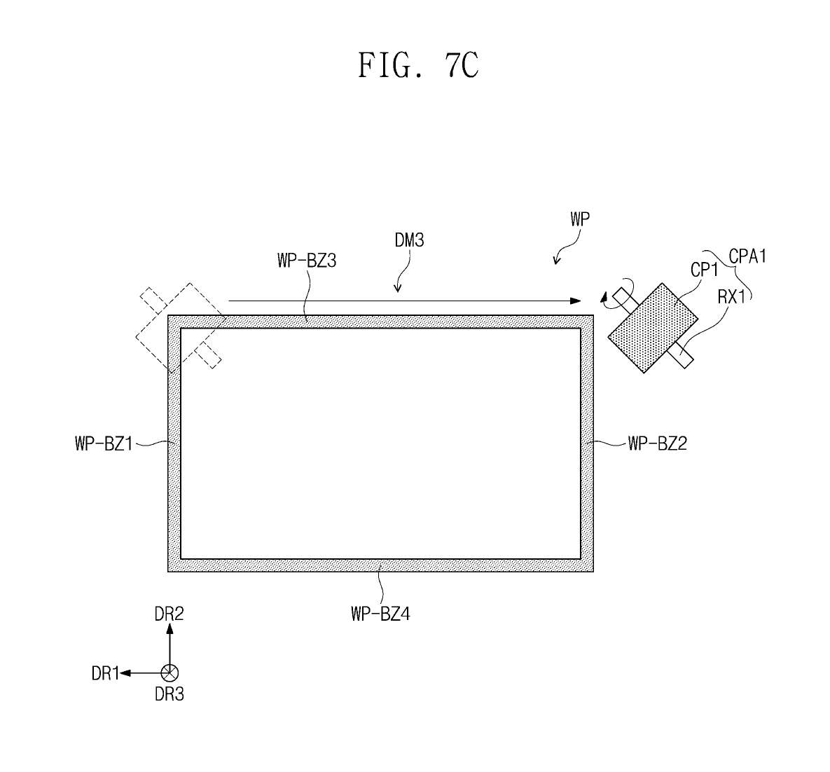

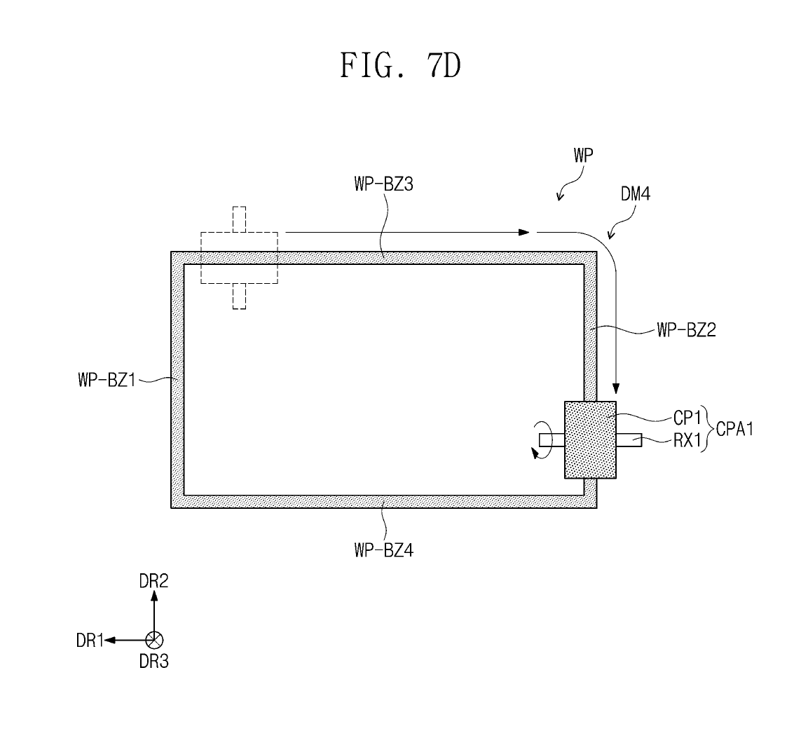

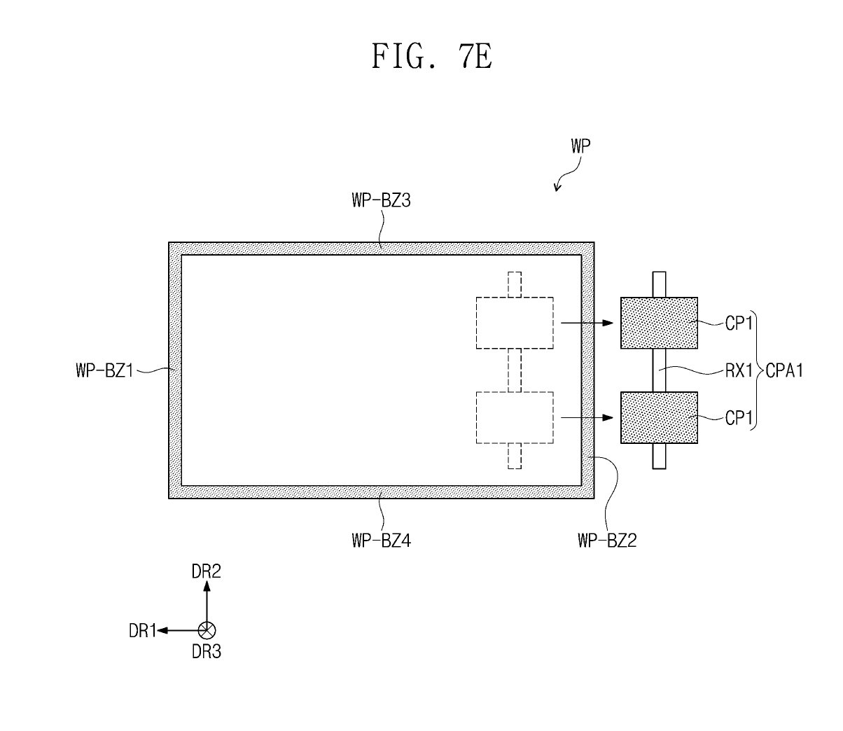

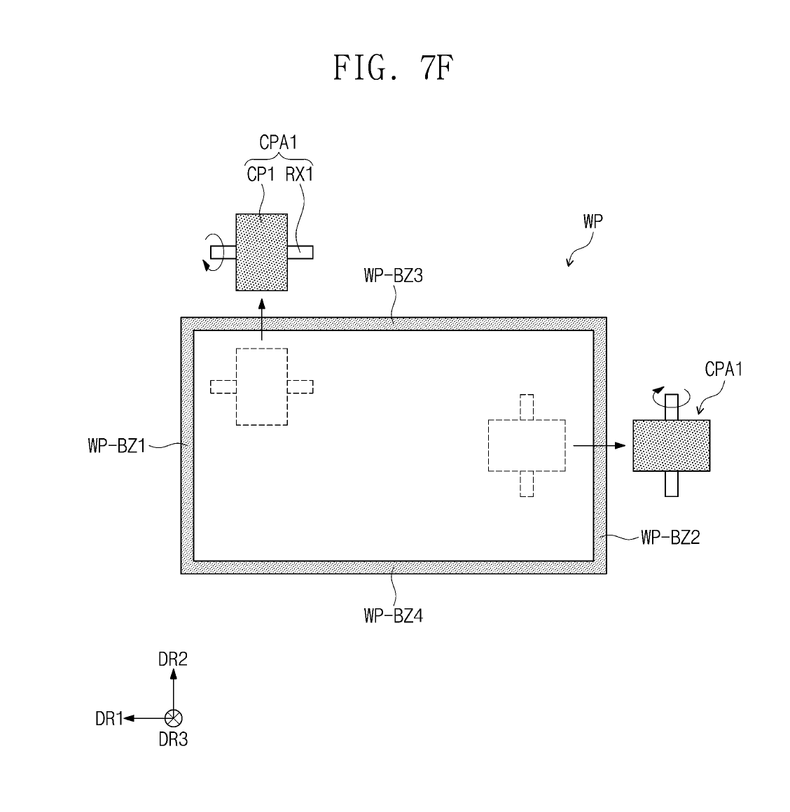

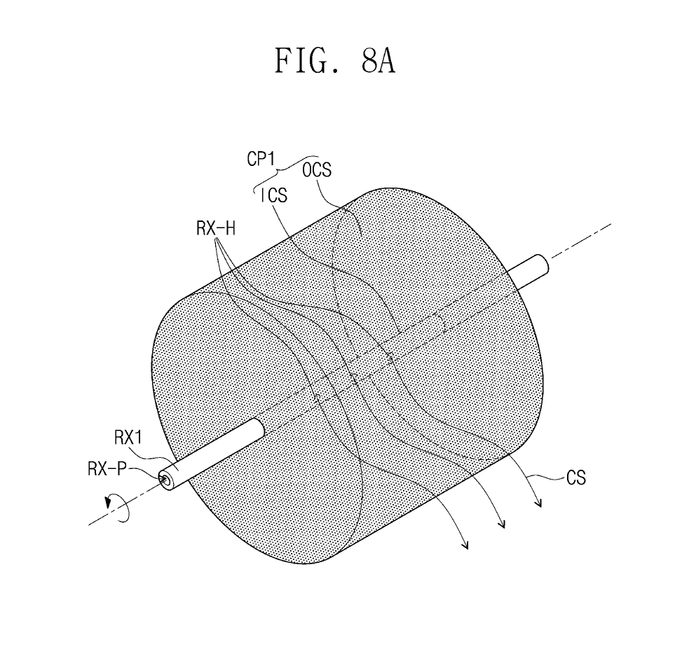

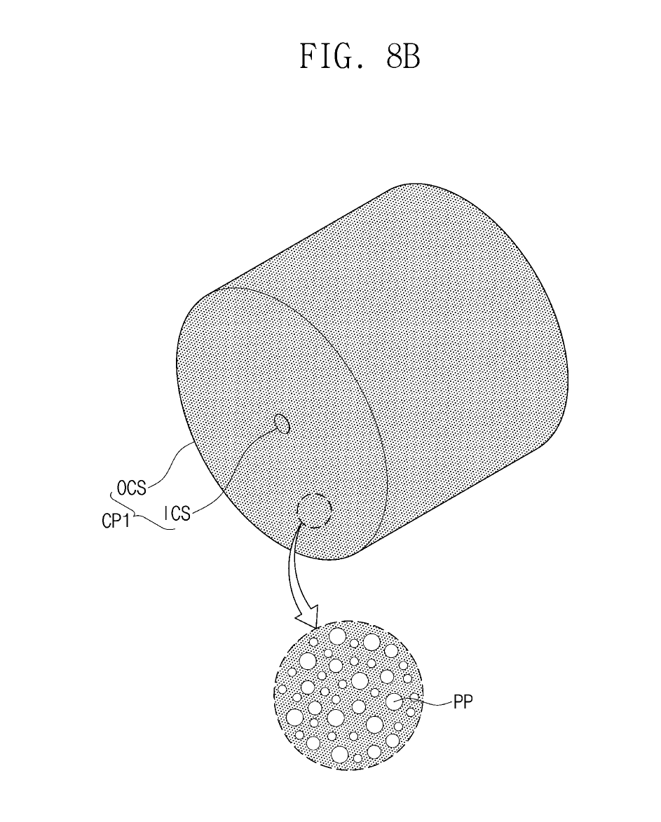

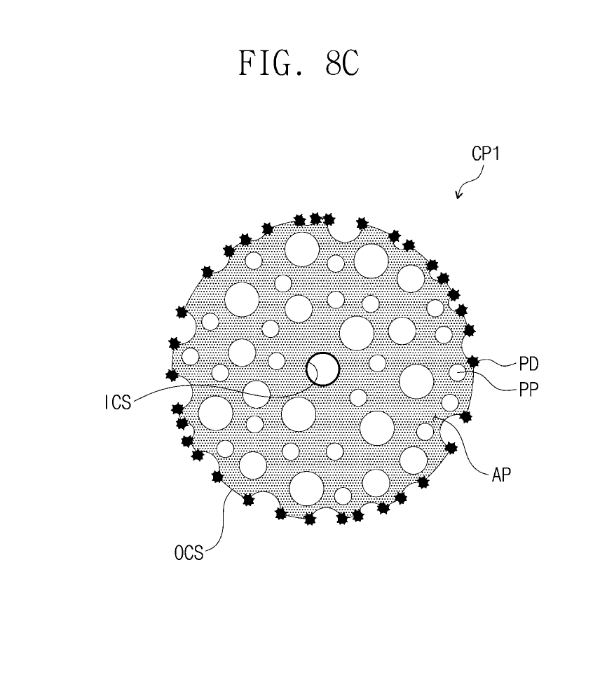

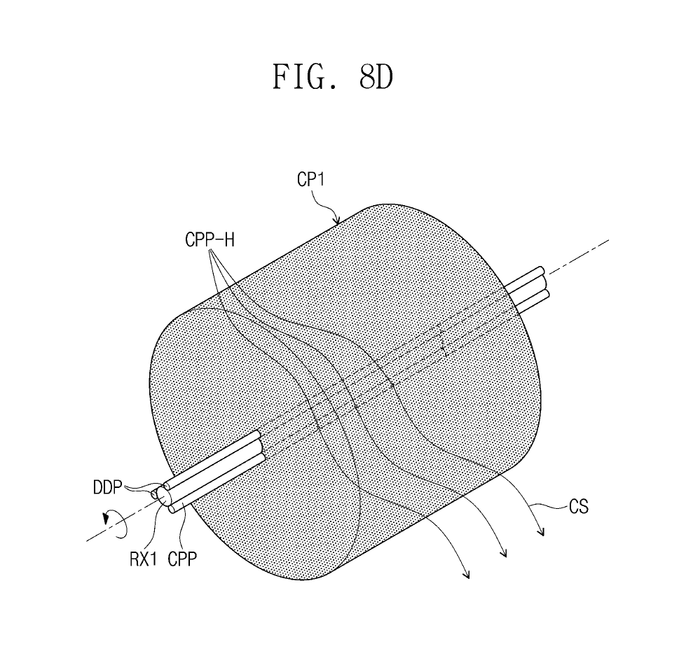

FIG. 7A is a perspective view illustrating the first adhesive removing device PCD1 according to an embodiment of the inventive concept. FIGS. 7B to 7F are plan views illustrating operations of the first cleaning pad assembly CPA1 according to an embodiment of the inventive concept. FIG. 8A is a perspective view illustrating the first cleaning pad assembly CPA1 according to an embodiment of the inventive concept. FIG. 8B is an enlarged perspective view illustrating a cleaning pad CP1 of the first cleaning pad assembly CPA1 shown in FIG. 8A. FIG. 8C is a sectional view of the cleaning pad CP1 shown in FIG. 8B. FIG. 8D is a perspective view illustrating the first cleaning pad assembly CPA1 according to an embodiment of the inventive concept.

As shown in FIG. 7A, the first adhesive removing device PCD1 may include a supporter SPM supporting the window panel WP, the first cleaning pad assembly CPA1, a rotary driving device RDM rotating the first cleaning pad assembly CPA1, a cleaning solution supplying device CSM supplying a cleaning solution to the first cleaning pad assembly CPA1, a position control device PCM controlling displacement of the first cleaning pad assembly CPA1, and a central control device CM controlling the rotary driving device RDM, the cleaning solution supplying device CSM, and the position control device PCM.

The supporter SPM may be moved by an in-line system (not shown). Alternatively, the supporter SPM may be a component constituting the in-line system. The supporter SPM may be a block constituting a conveyor system.

The first cleaning pad assembly CPA1 may include a first rotating member RX1 and a cylindrical cleaning pad CP1 (hereinafter, referred to as a first cleaning pad). The first cleaning pad CP1 may have an outer circumference surface rubbing against the adhesive residue PSA-R (e.g., see FIGS. 4B and 4C) and removing the adhesive residue PSA-R from the window panel WP. The rotary driving device RDM may produce a driving force for rotating first cleaning pad CP1 about a rotating axis of the first rotating member RX1. The rotary driving device RDM may include a motor. The cleaning solution supplying device CSM may supply cleaning solution to the first cleaning pad CP1. The cleaning solution may be the same as the cleaning solution CS stored in the chemical cleaning device CCD of FIG. 6. The cleaning solution supplying device CSM may include a cleaning solution storage tank (not shown) and a cleaning solution exhausting pump (not shown).

The position control device PCM may be coupled to the rotary driving device RDM and may be used to control motion of the first cleaning pad assembly CPA1. The cleaning solution supplying device CSM may also be coupled to the position control device PCM. The position control device PCM may include a mechanical structure such as a robot arm. The central control device CM may control a rotational direction and a rotational speed of the rotary driving device RDM, an amount or flow rate of the cleaning solution supplied from the cleaning solution supplying device CSM. The central control device CM may further control an operational period and/or an operational path of the position control device PCM. The central control device CM may include a computer system.

As shown in FIG. 7B, the first cleaning pad assembly CPA1 may be driven in various operational modes. In a first operational mode DM1, the first cleaning pad assembly CPA1 may be moved along the first direction DR1, while keeping the rotating axis of the first rotating member RX1 parallel to the second direction axis DR2. In the first operational mode DM1, the adhesive residue PSA-R may be removed from the cover layer WP-BZV shown in FIG. 4C. In a second operational mode DM2, the first cleaning pad assembly CPA1 may be moved along the second direction DR2, while keeping the rotating axis of the first rotating member RX1 parallel to the first direction axis DR1. In the second operational mode DM2, the adhesive residue PSA-R may be removed from the cover layer WP-BZV shown in FIG. 4B.

Referring to FIG. 7C, in a third operational mode DM3, the first cleaning pad assembly CPA1 may be moved along the first direction DR1, while keeping the rotating axis of the first rotating member RX1 inclined to the first direction axis DR1. In such a manner, the adhesive residue PSA-R may be removed from the third portion WP-BZ3 and the fourth portion WP-BZ4. The adhesive residue PSA-R on the first portion WP-BZ1 and the second portion WP-BZ2 may also be removed in a similar manner.

Referring to FIG. 7D, in a fourth operational mode DM4, the first cleaning pad assembly CPA1 may be moved along the first direction DR1, while keeping the rotating axis of the first rotating member RX1 parallel to the second direction axis DR2. Near an end portion of the third portion WP-BZ3, the first cleaning pad assembly CPA1 may be rotated by 90° to clean a border region between the third portion WP-BZ3 and the second portion WP-BZ2, and then, the first cleaning pad assembly CPA1 may be moved along the second direction DR2 to clean the second portion WP-BZ2, while keeping the rotating axis of the first rotating member RX1 parallel to the first direction axis DR1.

As shown in FIG. 7E, the first cleaning pad assembly CPA1 includes two first cleaning pads CP1 that are coupled to the first rotating member RX1. The first cleaning pads CP1 may be spaced apart from each other by a specific distance. The first cleaning pad assembly CPA1 shown in FIG. 7E may be driven in at least one of the first to fourth operational modes DM1 to DM4 described above.

As shown in FIG. 7F, the first adhesive removing device PCD1 may include two or more first cleaning pad assemblies CPA1. For example, the first adhesive removing device PCD1 may include a pair of first cleaning pad assemblies CPA1 that are driven in at least two different modes selected from the first to fourth operational modes DM1 to DM4. One of the pair of the first cleaning pad assemblies CPA1 may be driven in one mode of the first to fourth operational modes DM1 to DM4, and the other of the pair of the first cleaning pad assemblies CPA1 may be driven in the one mode (e.g., after a specific interval of time). The first adhesive removing device PCD1 may include a plurality of rotary driving devices RDM, a plurality of cleaning solution supplying devices CSM, and a plurality of position control devices PCM that correspond to the plurality of first cleaning pad assemblies CPA1, respectively. In some embodiments, some of the plurality of rotary driving devices RDM, the plurality of cleaning solution supplying devices CSM, and the plurality of position control devices PCM may be shared between the plurality of first cleaning pad assemblies CPA1.

Referring to FIGS. 8A and 8B, the first cleaning pad CP1 may include an outer circumference surface OCS and an internal circumference surface ICS. The first cleaning pad CP1 may be coupled to the first rotating member RX1 through the internal circumference surface ICS.

As shown in FIG. 8C, the first cleaning pad CP1 may include an elastic member AP and a powder layer. A plurality of pores PP may be formed in the elastic member AP. Some of the pores PP may be connected to each other to form passages between the outer circumference surface OCS and the internal circumference surface ICS.

The elastic member AP may include a cylindrical member having an elastic property. The elastic member AP may include a synthetic resin, for example, a urethane resin.

The powder layer may include a synthetic resin and a plurality of powder particles PD that are mixed on the synthetic resin. Although only the powder particles PD are illustrated in FIG. 8C, the powder layer may be a coating layer and may be provided on an outer surface of the elastic member AP or the outer circumference surface OCS of the first cleaning pad CP1.

The powder layer may include a synthetic resin, for example, a phenolic resin. The powder particles PD may be formed of or include a ceramic material whose Knoop hardness ranges from 2 to 3. The powder particles PD may have a diameter ranging from 0.3 μm to 0.5 μm. The adhesive residue PSA-R may be more easily removed by friction or rubbing of the powder particles PD against the adhesive residue PSA-R.

In an embodiment, the first cleaning pad CP1 may include only the elastic member AP. Here, the elastic member AP may be rotated to directly rub against the adhesive residue PSA-R.

As shown in FIG. 8A, a passage RX-P may be defined in the first rotating member RX1 to allow a cleaning solution to be flowed in an extension direction of the first rotating member RX1. In addition, an exit hole RX-H may be defined in the first rotating member RX1 to allow the cleaning solution to be discharged from the passage RX-P to an outside of the first rotating member RX1. In an embodiment, the first rotating member RX1 may include a plurality of exit holes RX-H that are arranged in a line. The exit hole RX-H may be used to discharge the cleaning solution CS to the internal circumference surface ICS of the first cleaning pad CP1.

In the case where the first cleaning pad CP1 is rotated, the cleaning solution CS provided onto the internal circumference surface ICS may be supplied onto the outer circumference surface OCS through the pores PP. In the case where the adhesive residue PSA-R is rubbed by the first cleaning pad CP1, an adhesive material filling the pores PP of the first cleaning pad CP1 may be pushed out of the first cleaning pad CP1 by the cleaning solution CS. Thus, the first cleaning pad CP1 may be automatically washed during the cleaning process, and thus, it may be unnecessary to perform a washing process of the first cleaning pad assembly CPA1.

Referring to FIG. 8D, the passage RX-P shown in FIG. 8A may not be defined in the first rotating member RX1. Instead, the first adhesive removing device PCD1 may further include a cleaning solution supply pipe CPP coupled to the first rotating member RX1. The cleaning solution supply pipe CPP may include at least one exit hole CPP-H that is used to discharge the cleaning solution CS.

In one embodiment, the first adhesive removing device PCD1 may further include one or more dummy pipes DDP that are coupled to the first rotating member RX1 to adjust a rotational balance of the first rotating member RX1. Each of the dummy pipes DDP and the cleaning solution supply pipe CPP may be provided in plural. To prevent the first rotating member RX1 from vibrating, the dummy pipe DDP and the cleaning solution supply pipe CPP may be symmetrically provided on an outer circumference surface of the first rotating member RX1 and may be spaced apart from each other by a uniform distance. In an embodiment, the first adhesive removing device PCD1 may have only a plurality of cleaning solution supply pipes CPP, without the dummy pipe DDP.

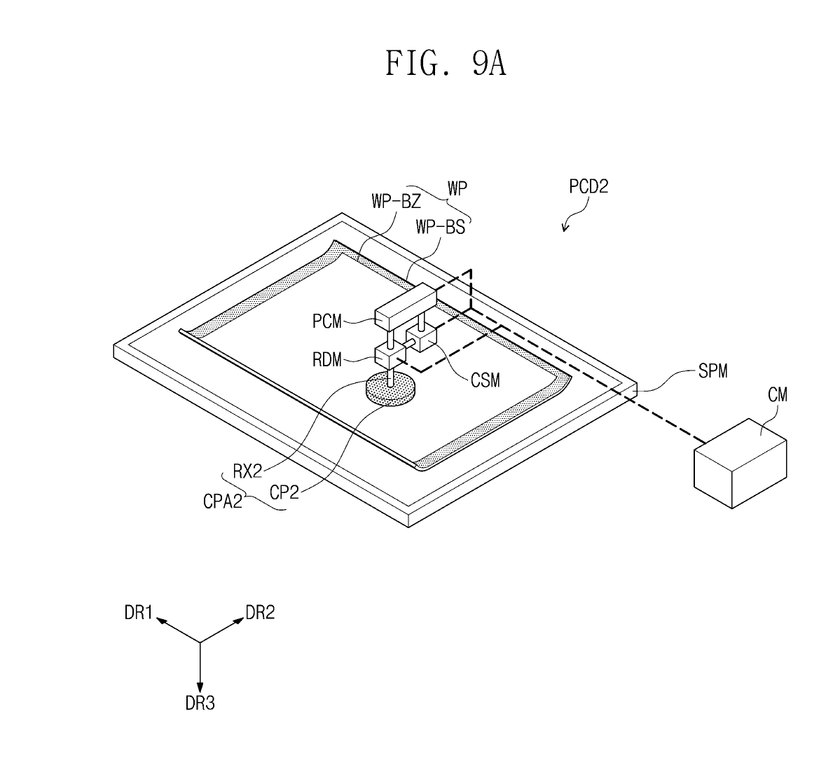

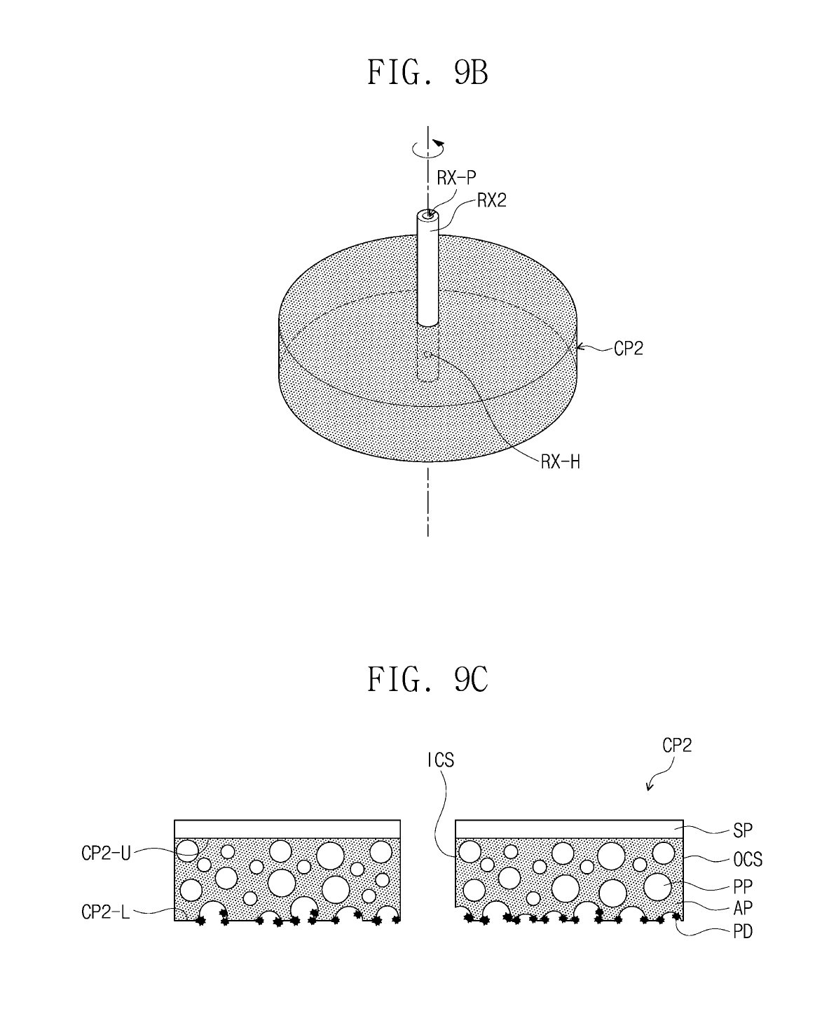

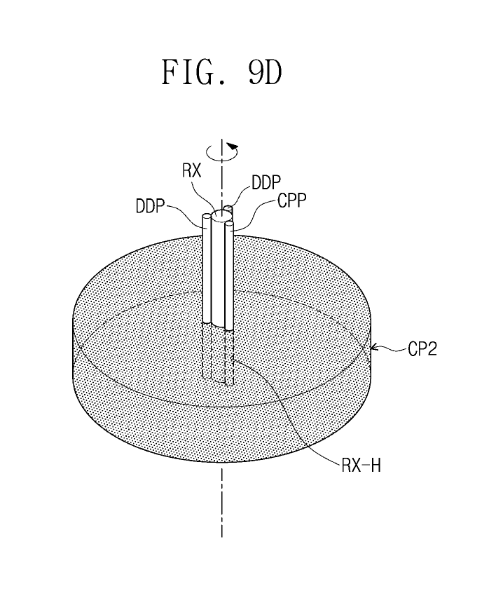

FIG. 9A is a perspective view illustrating the second adhesive removing device PCD2 according to an embodiment of the inventive concept. FIG. 9B is a perspective view illustrating the second cleaning pad assembly CPA2 according to an embodiment of the inventive concept. FIG. 9C is a sectional view of a cleaning pad shown in FIG. 9B. FIG. 9D is a perspective view illustrating a second cleaning pad assembly according to an embodiment of the inventive concept. Hereinafter, a detailed description of the same element as the first adhesive removing device PCD1 will be omitted.

As shown in FIG. 9A, the second adhesive removing device PCD2 may include the supporter SPM supporting the window panel WP, the second cleaning pad assembly CPA2, the rotary driving device RDM rotating the second cleaning pad assembly CPA2, the cleaning solution supplying device CSM supplying a cleaning solution to the second cleaning pad assembly CPA2, the position control device PCM controlling displacement of the second cleaning pad assembly CPA2, and the central control device CM controlling the rotary driving device RDM, the cleaning solution supplying device CSM, and the position control device PCM.

The supporter SPM may be a supporter transferred from the first adhesive removing device PCD1 through the in-line system. In one embodiment, the second adhesive removing device PCD2 is illustrated to include the cleaning solution supplying device CSM supplying the cleaning solution to the second cleaning pad assembly CPA2, but the cleaning solution supplying device CSM may be omitted from the second adhesive removing device PCD2, or the first and second adhesive removing devices PCD1 and PCD2 share the same cleaning solution supplying device CSM.

The second cleaning pad assembly CPA2 may include a second rotating member RX2 and a disk-shaped cleaning pad CP2 (hereinafter, referred to as a second cleaning pad). A bottom surface of the second cleaning pad CP2 may be used to rub against the adhesive residue PSA-R (e.g., see FIGS. 4B and 4C) and remove the adhesive residue PSA-R from the window panel WP. The second cleaning pad CP2 may remove the adhesive residue PSA-R provided on the flat region WP-F of the display region DD-DA. The second cleaning pad assembly CPA2 may be reciprocally moved along the first direction axis DR1 and/or the second direction axis DR2. In one embodiment, the second cleaning pad CP2 may be substantially the same as the first cleaning pad CP1, except for the difference in their shapes.

As shown in FIG. 9B, the passage RX-P may be defined in the second rotating member RX2. In addition, the exit hole RX-H may be defined in the second rotating member RX2. The second rotating member RX2 may be provided to have a plurality of exit holes RX-H that are arranged along an outer circumference surface and spaced apart from each other by a uniform distance.

As shown in FIG. 9C, the second cleaning pad CP2 may include a support plate SP, an elastic member AP, and a powder layer. The elastic member AP may have a disk shape and may be formed of or include substantially the same material as the elastic member AP of the first cleaning pad CP1.

A bottom surface CP2-L of the elastic member AP may be coated with the powder layer. A top surface CP2-U of the elastic member AP may be coupled or bonded to the support plate SP. The support plate SP may include stainless steel. In an embodiment, the powder layer and the support plate SP may be omitted. When the second cleaning pad CP2 is rotated, the cleaning solution provided onto the internal circumference surface ICS may be supplied onto the bottom surface CP2-L and the outer circumference surface OCS through the pores PP. When the second cleaning pad CP2 rotates and rubs against the adhesive residue PSA-R, an adhesive material that is detached from the window panel WP and fills the pores PP of the second cleaning pad CP2 may be pushed out of the second cleaning pad CP2 by the cleaning solution.

Referring to FIG. 9D, the passage RX-P may not be defined in the second rotating member RX2. Instead, the second adhesive removing device PCD2 may further include the cleaning solution supply pipe CPP coupled to the second rotating member RX2. The second adhesive removing device PCD2 may further include one or more dummy pipes DDP.

According to an embodiment of the inventive concept, a cylindrical elastic member, in which a plurality of pores are defined, may be used to remove an adhesive material from a curved region of a window panel. While the cylindrical elastic member is rotated to detach the adhesive material from the window panel and push the adhesive material to an outside. A light-blocking pattern of the curved region may not be damaged by the cleaning processes.

A plurality of cleaning pad assemblies may be used to quickly remove an adhesive material.

Since a cleaning solution is provided into the cylindrical elastic member, the cleaning solution may be discharged out of the cylindrical elastic member, during rotation of the cylindrical elastic member. The cleaning solution discharged out of the cylindrical elastic member may be used to remove an adhesive material from the pores. A process of cleaning the cleaning pad assembly may be omitted.

While example embodiments of the inventive concept have been particularly shown and described, it will be understood by one of ordinary skill in the art that variations in form and detail may be made therein without departing from the spirit and scope of the present disclosure.

What is claimed is:

1. A window panel recycling equipment, comprising:
a first cleaning pad assembly;
a first driving member rotating the first cleaning pad assembly; and
a cleaning solution supplying member supplying a cleaning solution to the first cleaning pad assembly,
wherein the first cleaning pad assembly comprises:
a first rotating member coupled to the first driving member; and
a first cleaning pad coupled to the first rotating member, the first cleaning pad having a cylindrical shape and having a plurality of pores defined therein.

2. The recycling equipment of claim 1, wherein the first rotating member includes:
a passage that allows the cleaning solution to flow in an extension direction of the first rotating member; and
an exit hole that allows the cleaning solution to be discharged from the passage to an outside of the first rotating member.

3. The recycling equipment of claim 1, further comprising a cleaning solution supply pipe coupled to the first rotating member.

4. The recycling equipment of claim 3, further comprising a dummy pipe coupled to the first rotating member.

5. The recycling equipment of claim 1, wherein the first cleaning pad comprises:
an elastic member; and
a powder layer coated on the elastic member.

6. The recycling equipment of claim 5, wherein the powder layer comprises a synthetic resin and ceramic powder particles that are mixed in the synthetic resin and have a diameter ranging from 0.3 μm to 0.5 μm.

7. The recycling equipment of claim 1, wherein the first cleaning pad assembly is provided in plural.

8. The recycling equipment of claim 1, wherein the cleaning solution comprises 90 weight percent (wt %) to 100 wt % of ethylcyclohexane, 0 wt % to 5 wt % of C9-11 isoalkanes, and 0 wt % to 10 wt % of C10-13 isoalkanes with respect to 100 wt % of the cleaning solution.

9. The recycling equipment of claim 1, further comprising:
a second cleaning pad assembly; and
a second driving member rotating the second cleaning pad assembly,
wherein the second cleaning pad assembly comprises:
a second rotating member coupled to the second driving member; and
a second cleaning pad coupled to the second rotating member, the second cleaning pad having a disk shape and having a plurality of pores defined therein.

10. The recycling equipment of claim 9, wherein the cleaning solution supplying member is configured to supply the cleaning solution to the second cleaning pad assembly, and
wherein the second rotating member includes:
a passage that allows the cleaning solution to flow in an extension direction of the second rotating member; and
an exit hole that allows the cleaning solution to be discharged from the passage of the second rotating member to an outside of the second rotating member.

11. The recycling equipment of claim 9, further comprising a cleaning solution supply pipe coupled to the second rotating member.

12. The recycling equipment of claim 11, further comprising a dummy pipe coupled to the second rotating member.

13. The recycling equipment of claim 1, wherein the first cleaning pad comprises an outer circumference surface that removes an adhesive residue from a curved region of a window panel by rotating the first cleaning pad.

14. The recycling equipment of claim 13, wherein the window panel comprises a base substrate and a light-blocking pattern that is directly provided on an edge region of the base substrate.

15. The recycling equipment of claim 1, further comprising:
a cleaning solution tank storing the cleaning solution, wherein the window panel is dipped in the cleaning solution;
a washing solution tank storing a washing solution, wherein the window panel is dipped in the washing solution;
an air dryer drying the window panel using an air; and
a fiber dryer drying the window panel using a fiber.

16. A window panel recycling method, comprising:
performing a chemical cleaning step to dip a window panel in a cleaning solution tank, the window panel including a base substrate including a curved region and a flat region, a light-blocking pattern that overlaps the curved region and is directly provided on the base substrate, and an adhesive residue;
performing a first physical cleaning step to clean the curved region of the window panel with a first cleaning pad assembly; and
removing the cleaning solution from the window panel,
wherein the first cleaning pad assembly comprises a first cleaning pad having a cylindrical shape and having a plurality of pores defined therein,
wherein the first cleaning pad rotates, and an outer circumference surface of the first cleaning pad rubs against the adhesive residue, and
wherein the cleaning solution is supplied onto an internal circumference surface of the first cleaning pad while the first cleaning pad rotates.

17. The method of claim 16, further comprising performing a second physical cleaning step to clean the flat region of the window panel with a second cleaning pad assembly,
wherein the second cleaning pad assembly comprises a second cleaning pad having a plurality of pores defined therein and having a disk shape, and
when the second cleaning pad rotates, and a bottom surface of the second cleaning pad rubs against the adhesive residue.

18. The method of claim 17, wherein the cleaning solution is supplied onto an internal circumference surface of the second cleaning pad while the second cleaning pad rotates.

19. The method of claim 16, wherein the removing of the cleaning solution from the window panel comprises dipping the window panel into a washing solution tank.

20. The method of claim 19, wherein the removing of the cleaning solution from the window panel further comprises:
taking the window panel out of the washing solution tank; and
drying the window panel using at least one of an air or a fiber.
